(19) United States
(12) Patent Application Publication
(10) Pub. No.: US 2006/0120750 A1
(43) Pub. Date: Jun. 8, 2006

(54) Image forming apparatus

(75) Inventor: Jai-il Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/167,092

(22) Filed: Jun. 28, 2005

(30) Foreign Application Priority Data
Dec. 8, 2004 (KR) 2004-103084

(51) Int. Cl. G03G 15/08

(52) U.S. Cl. 399/103

(57) ABSTRACT

An image forming apparatus including a first sealing member abutted against a developer roller to prevent toner from leaking out of a housing of a development unit, and a second sealing member that is abutted against a toner-supply roller to prevent the toner from moving toward the first sealing member.

### CROSS-REFERENCE TO RELATED APPLICATION

This application claims the priority of Korean Patent Application No. 2004-103084, filed on Dec. 8, 2004 in the Korean Intellectual Property Office, the disclosure of which is incorporated herein in its entirety by reference.

### BACKGROUND OF THE INVENTION

1. Field of the Invention

The present invention relates to an image forming apparatus, and more particularly, to an image forming apparatus with a development unit.

2. Description of the Related Art

Typically, an image forming apparatus receives a digital image data, forms a corresponding latent electrostatic image by exposing a photoconductor to a light beam scanned from a laser scan unit (LSU), develops the latent electrostatic image on the photoconductor into a visible toner image with toner, transfers the visible toner image to a printing medium, and fuses the toner image on the printing medium by applying heat and pressure to form a predetermined image.

Image forming apparatuses can be divided into dry and wet types depending on the toner and carrier, and the dry type can be further divided into two types: one-phase development type and two-phase development type.

The one-phase development type uses only the toner to form an image, and the two-phase development type uses the carrier containing the toner to form an image.

In the one-phase development type, a development unit applies the toner to the photoconductor to develop a visible toner image, a cleaning blade removes any remaining toner off of the photoconductor after the visible toner image is transferred, and a toner collector collects the removed toner for reuse. In the two-phase development type, a development unit applies the toner of the carrier to the photoconductor to develop a visible toner image (the left carrier is collected), a cleaning blade removes a remaining toner of the photoconductor after the visible toner image is transferred, and a toner collector collects the removed toner to reuse it. When printing a color image, the remaining toner of the photoconductor is a mixture of several color toners, such that it is hard to reuse the remaining toner.

FIG. 1 is a sectional view of a development unit according to the related art, and FIG. 2 is an enlarged partial view of a development unit depicted in FIG. 1.

Referring to FIGS. 1 and 2, a development unit 10 includes a housing 13, a toner containing part 24, a doctor blade 25, a charge roller 26, a sealing member 30, an agitator 27, and a waste toner cleaner 28.

The housing 13 includes an upper case 11 and a lower case 12. In the housing 13, a photoconductor 21, a developer roller 22, and a toner-supply roller 23 are disposed. Some portion of the photoconductor 21 is exposed such that the photoconductor 21 as it rotates receives a laser beam scanned from an exposing unit (not shown) to form an electrostatic latent image corresponding to an image data. The developer roller 22 applies toner to the electrostatic latent image formed on a surface of the photoconductor 21. The toner-supply roller 23 supplies the toner to the developer roller 22.

The toner containing part 24 stores the toner. The doctor blade 25 is fixed above the developer roller 22 and one end of the doctor blade 25 is abutted on the outer surface of the developer roller 22 to regulate the thickness of the toner attached on the developer roller 22. The charge roller 26 is disposed adjacent to the photoconductor 21 to charge the photoconductor 21 to have a predetermined potential.

The sealing member 30 is disposed under the developer roller 22 in an axial direction of the developer roller 22. The sealing member 30 has one end fixed to the lower case 12 and the other end abutted on the outer surface of the developer roller 22. The sealing member 30 is used to minimize toner leakage.

The agitator 27 stirs the toner in the toner containing part 24 to prevent the toner from hardening.

After a toner image is transferred from the photoconductor 21 to a printing medium (not shown), the waste toner cleaner 28 removes the remaining toner from the photoconductor 21, and a waste toner collecting part 29 stores the removed toner.

The sealing member 30 is a flexible film and it is tightly abutted against the developer roller 22, such that leakage of the toner in the housing 13 can be minimized.

When the toner is used up, the development unit 10 is replaced with a new one. However, when the development unit 10 is dropped or collides with other objects, the developer roller 10 is impacted. Such impact may cause the sealing member 30 to be separated from the developer roller 22 and therefore the toner may leak from the housing 13 as illustrated in FIG. 3. The particles of the toner are very fine, having a diameter less than 8 μm. Therefore, the toner can leak from the housing through a very tiny gap, resulting in image deterioration.

Particularly, impact on the development unit 10 increases the pressure in the toner containing part 24, causing the toner to rush toward the developer roller 22 through a gap 17 between the toner-supply roller 23 and the lower case 12. The toner rushed to the developer roller 22 with the increased pressure makes a space between the sealing member 30 and the developer roller 22 as shown in FIG. 3, and thereby the toner leaks out of the housing 13 through the space.

### SUMMARY OF THE INVENTION

Aspects of the present invention provide an image forming apparatus, in which a sealing member prevents toner from leaking even when a development unit of the image forming apparatus is impacted.

Additional aspects and/or advantages of the invention will be set forth in part in the description which follows and, in part, will be obvious from the description, or may be learned by practice of the invention.

According to an aspect of the present invention, there is provided an image forming apparatus having a development unit including a photoconductor, a developer roller forming a toner image on the photoconductor, and a toner-supply roller supplying toner to the developer roller, including: a first sealing member abutted on the developer roller to prevent the toner from leaking out of a housing of the development unit; and a second sealing member abutted on the toner-supply roller to prevent the toner from moving toward the first sealing member.

According to an aspect of the present invention, there is provided a leak resistant development unit detachably mountable with an image forming apparatus, comprising: a housing having an upper case and a lower case, the housing including: a toner containing part to hold toner; a photoconductor on which an image is formable; a developer roller which applies toner to the image on the photoconductor; a toner supply roller supplying the toner from the toner containing part to the developer roller; a first seal disposed to maintain contact with the developer roller such that the toner does not leak from the housing; and a second seal disposed to maintain contact with the toner supply roller such that the toner in the toner containing part does not flow to the first seal.

According to an aspect of the present invention, a development unit detachably mountable with an image forming apparatus is provided, the development unit comprising: a toner containing part holding toner; a toner supply roller discharging the toner from the toner containing part to a developer roller; a first seal disposed to maintain contact with the developer roller such that the toner does not leak from the development unit; and a second seal disposed to maintain contact with the toner supply roller such that the toner in the toner containing part does not flow to the first seal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view of a development unit according to the related art;

FIG. 2 is an enlarged partial view of the development unit depicted in FIG. 1;

FIG. 3 is a view showing leakage of toner when a development unit is impacted according to the related art;

FIG. 4 is a sectional view of an image forming apparatus in which a sealing member is applied to a development unit according to an embodiment of the present invention;

FIG. 5 is a sectional view of a development unit according to an embodiment of the present invention;

FIG. 6 is an enlarged partial view of the development unit employing a sealing member shown in FIG. 5 according to an embodiment of the present invention; and

FIG. 7 is an enlarged partial view of a development unit employing a sealing member according to another embodiment of the present invention.

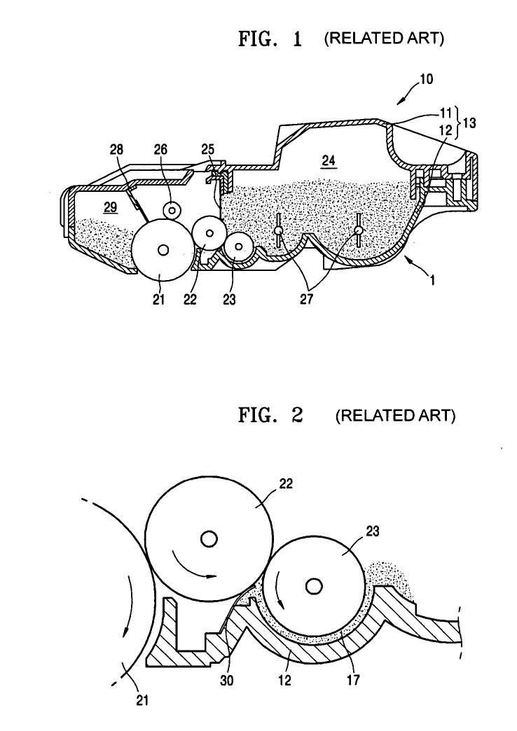

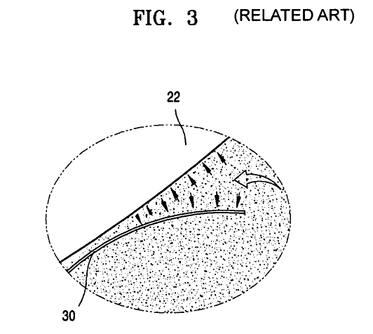

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

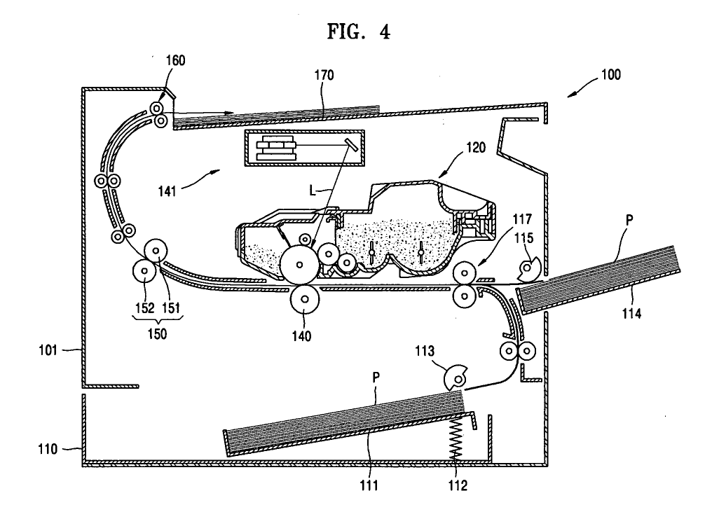

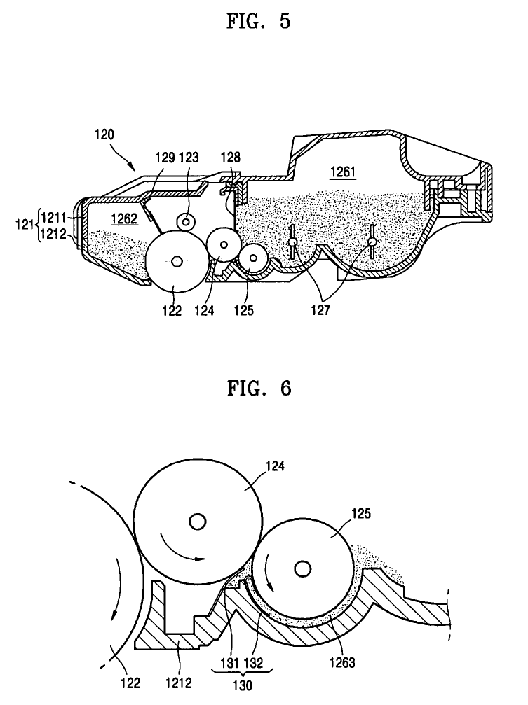

FIG. 4 is a sectional view of an image forming apparatus in which a sealing member is applied to a development unit according to an embodiment of the present invention, and FIG. 5 is a sectional view of a development unit according to an embodiment of the present invention.

Referring to FIGS. 4 and 5, an image forming apparatus 100 includes a main body housing 101, an exposing unit 141, a development unit 120, transfer roller 140, and a fusing unit 150.

The development unit 120 is a cartridge type unit that is detachably installed in the main body housing 101. The main body housing 121 of the development unit 120 includes an upper case 1211 and a lower case 1212. In the main body housing 121, a photoconductor 122, a charge roller 123, a developer roller 124, a toner-supply roller 125, a doctor blade 128, and a waste toner cleaner 129 are disposed.

Further, the development unit 120 includes a toner containing part 1261 in the housing 121 to store toner (i.e., developer). When the toner is used up, the development unit 120 is replaced with new one.

The photoconductor 122 includes a cylindrical metal drum and a photoconductive layer formed on the surface of the cylindrical metal drum. The charge roller 123 charges the photoconductor 122 to have a predetermined potential, and the exposing unit 141 scans a laser beam across the photoconductor 122 to form an electrostatic latent image corresponding to an image data.

The developer roller 124 applies the toner to the electrostatic latent image of the photoconductor 122 to form a visible toner image. The toner-supply roller 125 supplies the toner to the developer roller 124. The agitator 127 stirs the toner in the toner containing part 1261 to prevent the toner from hardening.

The doctor blade 128 regulates the thickness of the toner attached on the developer roller 124 after the toner-supply roller 125 supplies the toner.

The waste toner cleaner 129 removes remaining toner on the photoconductor 122 after the toner image is transferred to a printing medium (P). The removed toner is stored in a waste toner collecting part 1262.

The transfer roller 140 is brought into contact with the photoconductor 122 with pressure, and a transfer bias voltage may be applied between the transfer roller 140 and the photoconductor 122. This pressure and/or transfer bias voltage enables the toner image of the photoconductor 122 to be transferred to the printing medium (P) as the printing medium (P) passes between the transfer roller 140 and the photoconductor 122.

The fuser 150 includes a heat roller 151 and a pressure roller 152 engaged with the heat roller 151. The printing medium (P) on which the image is transferred is heated and pressed as it passes through the heat roller 151 and the pressure roller 152, such that the image can be securely attached to the printing medium (P).

Further, the image forming apparatus 100 includes a cassette 110, having a first tray 111 biasing the printing medium (P) with a spring 112, under the main body housing 101, a second tray 114 at a side of the main body housing 101, pick-up rollers 113 and 115, registration rollers 117, and eject rollers 160. A stack or a single sheet of printing medium (P) is loaded in the cassette 110 and the second tray 114. The pick-up rollers 113 and 115 pick up the printing medium (P) one by one from the cassette 110 or the second tray 114, respectively. The registration rollers 117 adjust the alignment of the printing medium (P) and then feed the printing medium (P) between the photoconductor 122 and the transfer roller 140, such that the toner image can be exactly transferred to the printing medium (P) from the photoconductor 122.

The eject rollers 160 eject the printing medium (P) out of the image forming apparatus 100 after the printing medium (P) is passed through the fuser 150. The ejected printing medium (P) can accumulate at an output tray 170.

The operation of the image forming apparatus 100 will now be described with respect to FIGS. 4 and 5.

The charge roller 123 charges the photoconductor 122 to have a predetermined potential, and the exposing unit 141 scans a laser beam across the photoconductor 122 to form an electrostatic latent image corresponding to an image data.

The agitator 127 agitates the toner in the toner containing part 1261 of the development unit 120, the toner-supply roller 125 supplies the toner to the developer roller 124, and the developer roller 124 applies the toner to the electrostatic latent image on the photoconductor 122 to form a visible toner image on the outer surface of the photoconductor 122.

The pick-up roller 113 or 115 picks up a printing medium (P) from the first tray 111 or the second tray 114. The registration rollers 117 align the printing medium (P) and feed it between the photoconductor 122 and the transfer roller 140. As the printing medium (P) passes between the photoconductor 122 and the transfer roller 140, the toner image is transferred from the photoconductor 122 to the printing medium (P).

Since the transferred toner image is loosely attached on the printing medium (P), the fuser 150 applies heat and pressure to the toner image to securely attach the toner image on the printing medium (P). After the fusing, the printing medium (P) is ejected by the eject rollers 160 and is placed in the output tray 170.

FIG. 6 is an enlarged partial view of a development unit employing a sealing member according to an embodiment of the present invention. Referring to FIG. 6, the sealing member 130 includes a first sealing member 131 and a second sealing member 132. The first sealing member 131 and the second sealing member 132 are thin flexible rectangular shaped members. It is understood that the first and second sealing members 131 and 132 are not limited to rectangular shapes and that other shapes may be used.

The first sealing member 131 has a first side portion and a second side portion, parallel with the first side portion, that are disposed in the axial direction of the developer roller 124. A third side portion of the first sealing member 131 is fixed to the lower case 1212 under the developer roller 124, and a fourth side portion is abutted against the surface of the developer roller 124. The first sealing member 131 has a predetermined elasticity and it is slightly bent when abutted against the developer roller 124, such that the first sealing member is securely abutted against the developer roller 124 without separation.

The second sealing member 132 has a first side portion and a second side portion that are disposed in the axial direction of the toner-supply roller 125. A third side portion, orthogonal to the first and second side portions, is fixed to the lower case 1212 under the toner-supply roller 125, and a fourth side portion is abutted against the surface of the toner-supply roller 125.

The fourth side portion of the second sealing member 132 may be bent into a U-shape and a terminating end may be pointing in the same direction as the rotational direction of the toner-supply roller 125 as shown in FIG. 6. The second sealing member 132 prevents the toner in a gap 1263 between the toner-supply roller 125 and the lower case 1212 from flowing toward the first sealing member 131. As discussed above, such a flow is especially problematic when the development unit 120 is impacted or dropped during or prior to installation in the image forming apparatus 100.

The second sealing member 132 may be a polyethylene terephthalate (PET) film and of a thickness in a range of 0.05 mm to 0.08 mm.

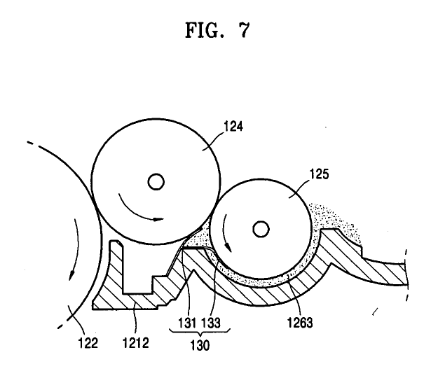

FIG. 7 is an enlarged partial view of a development unit employing a sealing member according to another embodiment of the present invention. Referring to FIG. 7, a sealing member 130 includes a first sealing member 131 and a second sealing member 133. The second sealing member 133 has a first side portion fixed to the lower case 1212 under the toner-supply roller 125, and a second side portion abutted against the surface of the toner-supply roller 125.

The terminating end of the second side portion is directed in the same direction as the rotational direction of the toner-supply roller 125 in order to prevent the toner in the gap 1263 from moving toward the first sealing member 131.

When the development unit 120 is impacted, the second sealing member 133 prevents the toner from moving toward the first sealing member 131, such that the first sealing member 131 is not affected by the pressure of toner impacted. Therefore, the sealing member 130 securely prevents the toner from leaking out of the development unit 120.

As described above, the image forming apparatus according to aspects of the present invention prevents toner from leaking out of the development unit even when the development unit is impacted. Therefore, the users can easily use and keep the development unit without the leakage of the toner.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus including a development unit including a photoconductor, a developer roller forming a toner image on the photoconductor, and a toner-supply roller supplying toner to the developer roller, comprising:
a first sealing member abutted on the developer roller to prevent the toner from leaking out of a housing of the development unit; and
a second sealing member abutted on the toner-supply roller to prevent the toner from moving toward the first sealing member.

2. The image forming apparatus of claim 1, wherein the housing has an upper case and a lower case, and the second sealing member has one end portion fixed to a predetermined portion of the lower case and another end portion bent in a rotational direction of the toner-supply roller to abut against the toner-supply roller.

3. The image forming apparatus of claim 2, wherein the other end portion of the second sealing member is bent into a U-shape.

4. The image forming apparatus of claim 3, wherein the second sealing member is disposed under the toner-supply roller.

5. The image forming apparatus of claim 1, wherein the second sealing member comprises:
one end portion fixed to a lower portion of the housing, the lower portion being disposed under the toner-supply roller; and
another end portion tightly abutted against the toner-supply roller.

6. The image forming apparatus of claim 5, wherein the other end portion of the second sealing member is tightly abutted against the toner-supply roller along a rotational direction of the toner-supply roller.

7. The image forming apparatus of claim 1, wherein the second sealing member is 0.05 mm to 0.08 mm in thickness.

8. A leak resistant development unit detachably mountable with an image forming apparatus, comprising:
a housing having an upper case and a lower case, the housing including:
a toner containing part to hold toner;
a photoconductor on which an image is formable;
a developer roller which applies toner to the image on the photoconductor;
a toner supply roller supplying the toner from the toner containing part to the developer roller;
a first seal disposed to maintain contact with the developer roller such that the toner does not leak from the housing; and
a second seal disposed to maintain contact with the toner supply roller such that the toner in the toner containing part does not flow to the first seal.

9. The development unit of claim 8, wherein the second seal is 0.05 mm to 0.08 mm in thickness.

10. The development unit of claim 9, wherein the second seal is polyethylene terephthalate.

11. The development unit of claim 8, wherein the second seal is U-shaped.

12. A development unit detachably mountable with an image forming apparatus, comprising:
a toner containing part holding toner;
a toner supply roller discharging the toner from the toner containing part to a developer roller;
a first seal disposed to maintain contact with the developer roller such that the toner does not leak from the development unit; and
a second seal disposed to maintain contact with the toner supply roller such that the toner in the toner containing part does not flow to the first seal.

13. The development unit of claim 12, wherein the second seal is polyethylene terephthalate.

14. The development unit of claim 12, wherein the second seal is 0.05 mm to 0.08 mm in thickness.

15. The development unit of claim 12, wherein the second seal is U-shaped.

16. The development unit of claim 12, wherein the second seal is disposed in a direction of rotation of the toner supply roller.
